(19) United States
(12) Patent Application Publication
(10) Pub. No.: US 2026/0261720 A1
(43) Pub. Date: Sep. 3, 2026

(54) METHOD, APPARATUS, DEVICE, STORAGE MEDIUM AND PRODUCT FOR RENDERING LIVE VIDEO STREAM

(71) Applicant: Beijing Zitiao Network Technology Co., Ltd., Haidian District, Beijing (CN)

(72) Inventors: Can Wang, Beijing (CN); Dong You, Beijing (CN); Jiawei Li, Beijing (CN)

(21) Appl. No.: 19/131,167

(22) PCT Filed: Nov. 13, 2023
(86) PCT No.: PCT/CN2023/131376

§ 371 Date: May 19, 2025

(30) Foreign Application Priority Data
Nov. 17, 2022 (CN) 202211441161.5

(51) Int. Cl. H04N 21/2187; H04N 5/262

(52) U.S. Cl. CPC H04N 21/2187; H04N 5/262

(57) ABSTRACT

Embodiments of the disclosure provide a method, apparatus, device, storage medium and product for rendering a live video stream. The method includes: the cloud server obtaining effect identification information and a live video stream corresponding to virtual reality live streaming, and determining a rendering mode corresponding to a target effect based on the effect identification information; if the rendering mode is a first rendering mode, the cloud server performing effect algorithm processing based on the live video stream and the effect identification information and effects rendering processing to obtain a target video stream; and if the rendering mode is a second rendering mode, the cloud server performing effect algorithm processing, and the virtual reality device performing effect rendering processing based on the live video stream and an algorithm result to obtain a processed target video stream, and playing the rendered video stream.

This application claims priority to Chinese Patent Application No. 202211441161.5, filed on Nov. 17, 2022, entitled “METHOD, APPARATUS, DEVICE, STORAGE MEDIUM, AND PRODUCT FOR RENDERING LIVE VIDEO STREAM’, which is incorporated herein by reference in its entirety.

### FIELD

Embodiments of the present disclosure relate to the technical field of image processing, and in particular, to a method, apparatus, device, storage medium and product for rendering a live video stream.

### BACKGROUND

With the development of science and technology, virtual reality (VR) technology gradually comes into the life of users. Users may realize 3D VR live streaming through VR technology. In a live VR streaming process, there is usually a need for effects rendering.

Existing live streaming scenarios are generally directed to normal live streaming at the mobile phone end. Since live streaming on mobile phones has a low resolution, an algorithm for effects rendering can be installed on mobile phones, so as to implement algorithm identification and rendering operations on mobile phones.

However, VR live streaming, due to the need for a sense of presence, imposes high requirements on clarity, and the live streaming picture is generally an ultra-high resolution picture. Effects rendering in the way described above affects hardware performance, and cannot guarantee real-time performance of live streaming.

### SUMMARY

The embodiments of the present disclosure provide a method, apparatus, device, storage medium and product for rendering a live video stream, so as to solve the technical problem that the existing rendering method cannot ensure the real-time performance of a rendering operation and the clarity of a rendering result.

In a first aspect, an embodiment of the present disclosure provides a method for rendering a live video stream, which is applied to a cloud rendering system, the cloud rendering system comprising a cloud server and a virtual reality device, the method comprising:
the cloud server obtaining effect identification information and a live video stream corresponding to virtual reality live streaming, the effect identification information being identification information of a target effect for rendering the live video stream; the cloud server determining a rendering mode corresponding to the target effect based on the effect identification information, wherein the rendering mode comprises a first rendering mode and/or a second rendering mode;
in accordance with a determination that the rendering mode is a first rendering mode, the cloud server performing effect algorithm processing based on the live video stream and the effect identification information and performing effect rendering processing based on an identification result corresponding to the effect algorithm processing to obtain a target video stream, and sending the target video stream to the virtual reality device, the virtual reality device obtaining and playing the target video stream sent from the cloud server; and
in accordance with a determination that the rendering mode is a second rendering mode, the cloud server performing effect algorithm processing based on the live video stream and the effect identification information and sending the live video stream and an identification result to the virtual reality device, the virtual reality device performing effect rendering processing based on the live video stream and an algorithm result to obtain a processed target video stream, and playing the processed target video stream.

In a second aspect, an embodiment of the present disclosure provides a method for rendering a live video stream, which is applied to a cloud server, the method comprising:
obtaining effect identification information and a live video stream corresponding to virtual reality live streaming, the effect identification information being identification information of a target effect for rendering the live video stream;
determining a rendering mode corresponding to the target effect based on the effect identification information;
performing rendering processing on the live video stream in the rendering mode corresponding to the target effect to obtain a processed target video stream; and
sending the target video stream to a preset virtual reality device for playing.

In a third aspect, an embodiment of the present disclosure provides a method for rendering a live video stream, which is applied to a virtual reality device, the method comprising:
obtaining a target video stream sent from a cloud server, the target video stream being obtained after the cloud server performs rendering processing in a rendering mode corresponding to the target effect based on effect identification information and a live video stream corresponding to virtual reality live streaming;
processing the target video stream in the rendering mode corresponding to the target effect to obtain a processed target video stream; and
playing the processed target video stream.

In a fourth aspect, an embodiment of the present disclosure provides an apparatus for rendering a live video stream, which is applied to a cloud rendering system, the apparatus comprising: a first obtaining module configured to obtain effect identification information and a live video stream corresponding to virtual reality live streaming, the effect identification information being identification information of a target effect for rendering the live video stream;
a determining module configured to determine a rendering mode corresponding to the target effect based on the effect identification information;
a rendering module configured to perform rendering processing on the live video stream by using the rendering mode corresponding to the target effect to obtain a processed target video stream; and
a sending module configured to send the target video stream to a preset virtual reality device for playing.

In a fifth aspect, an embodiment of the present disclosure provides an apparatus for rendering a live video stream, which is applied to a virtual reality device, the apparatus comprising:
a second obtaining module configured to obtain a target video stream sent from a cloud server, the target video stream being obtained after the cloud server performs, based on effect identification information and a live video stream corresponding to virtual reality live streaming, rendering processing in a rendering mode corresponding to the target effect;
a processing module configured to process the target video stream in the rendering mode corresponding to the target effect to obtain a processed target video stream; and
a playing module configured to play the processed target video stream.

In a sixth aspect, an embodiment of the present disclosure provides a cloud rendering system, comprising a cloud server and a virtual reality device, the cloud server being in communication connection with the virtual reality device;
wherein the cloud server is configured to: obtain effect identification information and a live video stream corresponding to virtual reality live streaming, and determine a rendering mode corresponding to target effect based on the effect identification information, the effect identification information being identification information of the target effect for rendering the live video stream;
the cloud server is further configured to: in accordance with a determination that the rendering mode is the first rendering mode, perform effect algorithm processing and effect rendering processing based on the live video stream and the effect identification information to obtain a target video stream;
the cloud server is further configured to: in accordance with a determination that the rendering mode is a second rendering mode, perform effect algorithm processing based on the live video stream and the effect identification information, and send the live video stream and an identification result to the virtual reality device;
the virtual reality device is configured to obtain the live video stream and the identification result sent from the cloud server to perform effect rendering processing.

In a seventh aspect, an embodiment of the present disclosure provides an electronic device, comprising: a processor and a memory,
the memory stores computer-executable instructions; and
the processor executes the computer-executable instructions stored in the memory so as to implement the method for rendering a live video stream according to the first aspect and various possible designs of the first aspect or the second aspect and various possible designs of the second aspect or the third aspect and various possible designs of the third aspect.

In an eighth aspect, an embodiment of the present disclosure provides a computer-readable storage medium, wherein the computer-readable storage medium stores computer-executable instructions which, when executed by a processor, implement the method for rendering a live video stream according to the first aspect and various possible designs of the first aspect or the second aspect and various possible designs of the second aspect or the third aspect and various possible designs of the third aspect.

In a ninth aspect, an embodiment of the present disclosure provides a computer program product, comprising a computer program, wherein the computer program, when executed by a processor, implements the method for rendering a live video stream according to the first aspect and various possible designs of the first aspect or the second aspect and various possible designs of the second aspect or the third aspect and various possible designs of the third aspect.

According to the method, apparatus, device, storage medium and product for rendering a live video stream provided by the embodiments, after obtaining effect identification information and a live video stream corresponding to virtual reality live streaming, algorithm identification processing and/or rendering processing on the live video stream corresponding to the virtual reality live streaming are implemented in a cloud server, thereby avoiding the pressure on a virtual reality device at the viewing end. In addition, different rendering processing modes are adopted for target effects of different types, so that a rendering operation may be performed on a target effect in a pertinent manner, thereby improving the accuracy and real-time performance of effects rendering.

### BRIEF DESCRIPTION OF THE DRAWINGS

In order to more clearly illustrate the technical solutions in the embodiments of the present disclosure or related technologies, the accompanying drawings used in the description of the embodiments or related technologies are briefly introduced below. It is obvious that the drawings in the following description are some embodiments of the present disclosure, and those of ordinary skill in the art may further derive other drawings from these drawings without the exercise of any inventive effort.

FIG. 1 is a system architecture diagram on which the present disclosure is based;

FIG. 2 is a schematic flowchart of a method for rendering a live video stream according to an embodiment of the present disclosure;

FIG. 3 is a schematic flowchart of a method for rendering a live video stream according to another embodiment of the present disclosure;

FIG. 4 is a schematic flowchart of a method for rendering a live video stream according to another embodiment of the present disclosure;

FIG. 5 is a schematic flowchart of a method for rendering a live video stream according to another embodiment of the present disclosure;

FIG. 6 is a schematic flowchart of a method for rendering a live video stream according to an embodiment of the present disclosure;

FIG. 7 is a schematic structural diagram of an apparatus for rendering a live video stream according to one embodiment of the present disclosure;

FIG. 8 is a schematic structural diagram of an apparatus for rendering a live video stream according to an embodiment of the present disclosure; and

FIG. 9 is a schematic structural diagram of an electronic device according to an embodiment of the present disclosure.

### DETAILED DESCRIPTION

In order to make the objectives, technical solutions and advantages of the embodiments of the present disclosure more apparent, the technical solutions in the embodiments of the present disclosure will be clearly and completely described below with reference to the accompanying drawings in the embodiments of the present disclosure. It is obvious that the embodiments to be described are merely part not all of the embodiments of the present disclosure. All other embodiments obtained by those skilled in the art based on the embodiments of the present disclosure without creative efforts shall fall within the scope of the present disclosure.

In order to solve the technical problem that the existing rendering method cannot ensure the real-time performance of a rendering operation and the clarity of a rendering result, the present disclosure provides a method, apparatus, device, storage medium, and product for rendering a live video stream.

It should be noted that, the method, apparatus, device, storage medium, and product for rendering a live video stream provided in the present disclosure may be applied to any virtual reality live rendering scenario, so as to ensure the real-time performance of virtual reality live streaming rendering and the clarity of live streaming content.

For ordinary live streaming, for example, live streaming running at the mobile phone end (hereinafter referred to as the Native end), an effects processing operation can always achieve performance expectation by running an identification algorithm and a rendering operation at the Native end, without requiring an input of a video picture with too high resolution. However, for VR live streaming, since a sense of presence is required, the requirement for clarity is very high, which presents a new challenge to algorithm processing.

In the process of solving the foregoing technical problem, the inventor has found through research that, in order to solve high picture quality of a VR live streaming picture, the calculation of effects algorithm cannot be performed at the Native end because of limited computing power of the Native end. Therefore, the calculation of the effects algorithm can be performed on a cloud server. That is, the computing power of the cloud server can be fully used, the original part of computing power at the Native end can be saved, and the clarity and the real-time performance of the rendering result can be ensured.

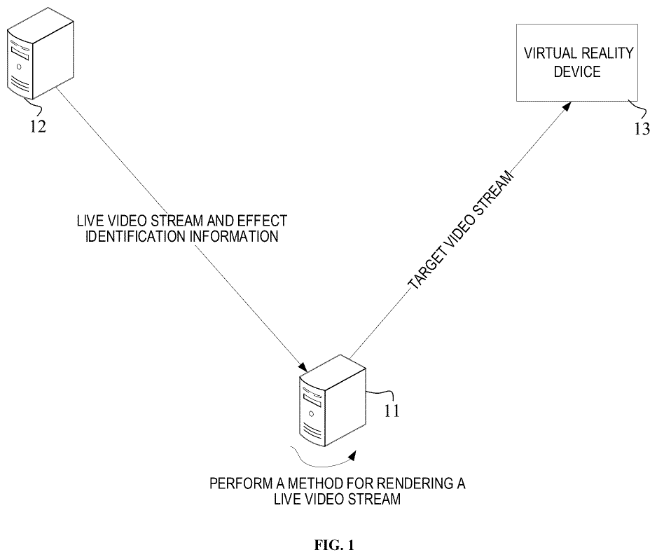

FIG. 1 is a system architecture diagram on which the present disclosure is based. As shown in FIG. 1, the system architecture on which the present disclosure is based includes at least a server 11, a live companion server 12, and a virtual reality device 13. The server 11 is provided with a live video stream rendering apparatus, which can be written in language such as C/C++, Java, Shell or Python; the virtual reality device 13 may be a VR device capable of implementing live content viewing, such as VR glasses.

Based on the described system architecture, the server 11 can obtain effect identification information and a live video stream corresponding to virtual reality live streaming sent from the live companion server 12. Rendering processing is performed on the live video stream in a rendering mode corresponding to a target effect based on the live video stream and the effect identification information, so as to obtain processed target video streaming, and the target video streaming is sent to the preset virtual reality device 13 for playing.

In order to realize a rendering operation on the live video stream on the basis of reducing the computing power of the virtual reality device, the present disclosure further provides a method for rendering a live video stream, which is applied to a cloud rendering system. The cloud rendering system comprises a cloud server and a virtual reality device. The method comprises:
the cloud server obtaining effect identification information and a live video stream corresponding to virtual reality live streaming, the effect identification information being identification information of a target effect for rendering the live video stream;
the cloud server determining a rendering mode corresponding to the target effect according to the effect identification information, wherein the rendering mode comprises a first rendering mode and/or a second rendering mode;
if the rendering mode is a first rendering mode, the cloud server performing effect algorithm processing according to the live video stream and the effect identification information, and performing effect rendering processing according to an identification result corresponding to the effect algorithm processing to obtain target video streaming, and sending the target video streaming to the virtual reality device, the virtual reality device obtaining and playing the target video streaming sent from the cloud server;
if the rendering mode is a second rendering mode, the cloud server performing effect algorithm processing according to the live video stream and the effect identification information, and sending the live video stream and an identification result to the virtual reality device, the virtual reality device performing effect rendering processing according to the live video stream and an algorithm result to obtain processed target video streaming, and play the processed target video streaming.

The present embodiment provides a cloud rendering system, which at least comprises a cloud server and a virtual reality device. The cloud server can separately obtain a live video stream corresponding to the virtual reality live streaming and effects identification information of a target effect for rendering the live video stream.

In practical applications, since different target effects may correspond to different display effect, rendering areas, and different requirements on the real time degree, etc., in order to ensure the rendering effect of the live video stream, different rendering modes may be preset for different target effects. Therefore, after obtaining a live video stream and effect identification information, the cloud server can determine a rendering mode corresponding to a target effect according to the effect identification information. The rendering mode includes a first rendering mode and/or a second rendering mode.

When the rendering mode is a first rendering mode, an effects algorithm and effects rendering may be implemented in the cloud server. A rendered target video stream is obtained, and the target video stream is sent to a virtual reality device. Therefore, after obtaining the target video stream, the virtual reality device may directly play the target video stream without further rendering processing.

When the rendering mode is a second rendering mode, an effects algorithm may be performed on the cloud server, and an identification result corresponding to the effects algorithm and the live video stream are sent together to the virtual reality device. Accordingly, after obtaining the identification result and the live video stream, the virtual reality device may perform effect rendering processing based on the identification result and the live video stream. In this way, real-time performance of the target effect can be ensured, and interaction between the streamer and the target effect can be supported.

It should be noted that, when the rendering mode only includes the first rendering mode, for all target effects, effect algorithm processing and effect rendering processing may be implemented on the cloud server. Thus, the computing power of the virtual reality device can be effectively saved, and the effect of virtual reality live streaming can be guaranteed.

When the rendering mode only includes the second rendering mode, for all target effect, effect algorithm processing may be performed on the cloud server, and an identification result corresponding to the effect algorithm processing is sent to the virtual reality device. The virtual reality device can perform effect rendering processing on the live video stream according to the identification result, so that the real-time performance of effects rendering can be ensured, and the streamer can further perform an interactive operation with a target effect, thereby further optimizing the live streaming effect.

When the rendering mode include both the first rendering mode and the second rendering mode, different rendering modes may be selected for rendering operations according to different target effects, so that the effects rendering operations can be implemented in a pertinent way. On the basis of improving the rendering effect, the real-time performance of the effects rendering operation is ensured.

Further, on the basis of any one of the above embodiments, the cloud server performing effect algorithm processing according to the live video stream and the effect identification information comprises:
the cloud server obtaining target data for rendering the target effect in a preset configuration platform based on the effect identification information;
the cloud server determining a target rendering area corresponding to the target effect according to the target data; and
the cloud server performing an identification operation on the live video stream to obtain an identification result corresponding to the live video stream, wherein the identification result comprises key point information corresponding to the target rendering area in a live image frame corresponding to the live video stream and depth data corresponding to the live image frame.

In this embodiment, a configuration platform may be preset, and the cloud server may further be in communication connection with the configuration platform. The configuration platform can store target data corresponding to a plurality of effects, wherein the target data includes but is not limited to a rendering mode corresponding to the effects, a rendering time corresponding to the effects, a rendering position corresponding to the effects, a decoration, etc.

Therefore, after obtaining the effect identification information and the live video stream corresponding to the virtual reality live streaming, the cloud server may obtain target data corresponding to the target effect from a preset configuration platform according to the effect identification information.

After the target data is obtained, information such as a target rendering area and depth corresponding to the target effect may be determined according to the target data. Further, an identification operation can be performed on the live video stream to obtain an identification result corresponding to the live video stream, wherein the identification result comprises key point information corresponding to the target rendering area in a live image frame corresponding to the live video stream and depth data corresponding to the live image frame.

Further, on the basis of any one of the foregoing embodiments, the performing effect rendering processing according to an identification result of the effect algorithm processing to obtain a target video stream comprises:
the cloud server performing a rendering operation on the live video stream according to the identification result and the target data to obtain a rendered video stream; and
the cloud server performing an encoding operation on the rendered video stream to obtain the target video stream.

In this embodiment, after the identification result corresponding to the live video stream is determined, a rendering operation may be accurately performed on the decoration in the target data according to the key point information and the depth data in the identification result to obtain a rendered video stream. Further, in order to facilitate data transmission, an encoding operation may be performed on the rendered video stream to obtain the target video stream.

When the rendering mode is the first rendering mode, an algorithm identification operation and a rendering operation on the live video stream are implemented in the cloud server, so that the target video stream can be obtained. After the target video stream is sent to the virtual reality device, the virtual reality device does not need to perform effects algorithm and effect rendering processing locally, thereby effectively saving the computing power of the virtual reality device.

Further, on the basis of any one of the above embodiments, after the cloud server determines the rendering mode corresponding to the target effect according to the effect identification information, the method further comprises:
the cloud server obtaining, according to the effect identification information, target data for rendering the target effect in a preset configuration platform;
the cloud server determining a target rendering area corresponding to the target effect according to the target data;
the cloud server performing an identification operation on the live video stream to obtain an identification result corresponding to the live video stream, wherein the identification result comprises key point information corresponding to the target rendering area in a live image frame corresponding to the live video stream and depth data corresponding to the live image frame; and
the cloud server performing an encoding operation on the live video stream, the identification result and the target data to obtain the target video stream, and sending the target video stream to the virtual reality device;
the virtual reality device obtaining the target video stream and performing a decoding operation on the target video stream to obtain a live video stream corresponding to the virtual reality live streaming, an identification result corresponding to the live video stream, and target data, wherein the identification result comprises key point information corresponding to the target rendering area in a live image frame corresponding to the live video stream and depth data corresponding to the live image frame; and
performing a rendering operation on the live video stream according to the identification result and the target data to obtain a processed target video stream.

In this embodiment, when the rendering mode corresponding to the target effect is the second rendering mode, that is, an effects algorithm operation is performed on the cloud server, and effect rendering processing is performed on the virtual reality device.

After obtaining the target data, the cloud server may determine, according to the target data, information such as a target rendering area and depth corresponding to the target effect. Further, an identification operation can be performed on the live video stream to obtain an identification result corresponding to the live video stream, where the identification result comprises key point information corresponding to the target rendering area in a live image frame corresponding to the live video stream and depth data corresponding to the live image frame.

After determining the identification result corresponding to the live video stream, the cloud server may perform an encoding operation on the live video stream, the identification result, and the target data to obtain a target video stream. The target video stream is sent to the virtual reality device.

Further, on the basis of any one of the foregoing embodiments, after the sending the target video stream to the virtual reality device, the method further comprises:

Accordingly, the virtual reality device may obtain the target video stream sent from the cloud server. After obtaining the target video stream, a decoding operation may be performed on the target video stream to obtain a live video stream corresponding to the virtual reality live streaming, an identification result corresponding to the live video stream, target data and a rendering time, wherein the identification result comprises key point information corresponding to the target rendering area in a live image frame corresponding to the live video stream and depth data corresponding to the live image frame.

A rendering operation is performed on the live video stream according to the identification result and the target data to obtain a processed target video stream. In this way, subsequently, the virtual reality device may play the target video stream.

When the rendering mode is the second rendering mode, calculation of an effects algorithm is performed on the cloud server, and effect rendering processing is performed in the virtual reality device, so that effects real-time performance can be ensured on the basis of saving computing power of the virtual reality device and the user can perform an interactive operation with the effects.

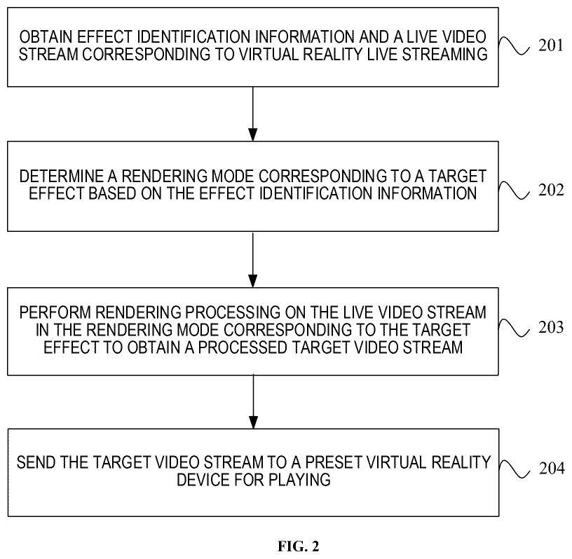

FIG. 2 is a schematic flowchart of a method for rendering a live video stream provided by an embodiment of the present disclosure, which is applied to a cloud server. As shown in FIG. 2, the method comprises:
Step 201: obtaining a live video stream corresponding to virtual reality live streaming and effect identification information, the effect identification information being identification information of a target effect for rendering the live video stream.

The execution body of this embodiment is a live video stream rendering apparatus, which may be coupled to a cloud server. The cloud server is communicatively connected with the virtual reality device and the virtual reality live streaming server, respectively.

In this embodiment, the streamer can launch virtual reality live streaming through a preset live streaming application, and the live streaming application can be installed in the virtual reality live streaming server. After the stream launches the virtual reality live streaming, live video streams may be collected using a preset binocular image collecting apparatus. Optionally, in the live streaming process, in order to optimize the live streaming effect, the stream may select a target effect for display. Alternatively, the viewer of the virtual reality live streaming may also trigger a virtual resource transfer operation according to an actual requirement, where the virtual resource transfer operation may correspond to a target effect on a one-to-one basis.

Therefore, the virtual reality live streaming server may obtain a live video stream and effect identification information, respectively, and send the live video stream and the effect identification information to the cloud server. Accordingly, the cloud server may obtain the live video stream and the effect identification information.

Step 202: determining a rendering mode corresponding to a target effect based on the effect identification information.

In this embodiment, different target effect may correspond to different display effect, rendering areas, and the like. For example, the target effect may be effects of a virtual eyeglass accessory, and when acting on the streamer's face, the effects can interact with the streamer in real time. When the target effect are triggered, a pair of glasses capable of performing a corresponding interaction operation based on the movement of the streamer may be rendered on the face of the streamer. The requirement of the target effect on time efficiency is strict.

Still for example, the target effect may be of the undersea world, which acts throughout the live streaming. After the target effect are triggered, a rendering operation may be performed on the background where the streamer is located. The target effect does not need to interact with the streamer, thus no requirement for the time effect.

For the different target effects, there may exist different rendering modes corresponding thereto. For example, for a target effect with a strict requirement on time effect, effects calculation may be implemented on the cloud server to obtain an identification result for the live video stream. A rendering operation is performed in the virtual reality device, so as to ensure real-time interaction with the user. For a target effect without a requirement for time effect, effects calculation and effects rendering may be implemented on the cloud server, and the virtual reality device may directly play the target video stream sent from the cloud server.

Therefore, in order to accurately perform a rendering operation on a target effect, after obtaining a live video stream and effect identification information, a rendering method corresponding to the target effect may be determined according to the effect identification information.

Step 203: perform rendering processing on the live video stream by using a rendering mode corresponding to the target effect to obtain a processed target video stream.

In this implementation, after determining the rendering mode corresponding to the target effect, the cloud server may perform rendering processing on the live video stream by using the rendering mode corresponding to the target effect, so as to obtain the processed target video stream, whereby the rendering processing includes at least one of effect algorithm processing and effect rendering processing.

Step 204: send the target video stream to a preset virtual reality device for playing.

In this implementation, after obtaining the target video stream, the target video stream may be sent to a preset virtual reality device for playing. By performing effect algorithm processing and/or effect rendering processing in the cloud server, the computing power of the virtual reality device can be effectively saved, and the pressure on the virtual reality device can be reduced.

According to the live video stream rendering method provided in this embodiment, after obtaining a live video stream corresponding to virtual reality live streaming and effect identification information, algorithm identification processing and/or rendering processing on the live video stream corresponding to the virtual reality live streaming are implemented in the cloud server, so that the pressure on the virtual reality device at the viewing end can be avoided. In addition, different rendering processing modes are adopted for target effects of different types, so that a rendering operation can be performed on a target effect in a pertinent manner, thereby improving the accuracy and real-time performance of effects rendering.

Further, on the basis of any of the above embodiments, Step 202 comprises:
obtaining target data corresponding to the target effect from a preset configuration platform according to the effect identification information;
determining a rendering mode corresponding to the target effect in the target data;
wherein the rendering mode comprises a first rendering mode and/or a second rendering mode.

In this embodiment, a configuration platform may be preset. The configuration platform may store target data corresponding to a plurality of effects, wherein the target data includes but is not limited to a rendering mode corresponding to the effects, a rendering time corresponding to the effects, a rendering position corresponding to the effects, a decoration, and the like.

Therefore, after obtaining the live video stream corresponding to the virtual reality live streaming and the effect identification information, target data corresponding to the target effect can be obtained in a preset configuration platform according to the effect identification information. Then a rendering mode corresponding to the target effect is determined in the target data.

The rendering mode comprises a first rendering mode and/or a second rendering mode. The first rendering mode may be a cloud rendering mode, that is, both an effects algorithm and effects rendering are performed in the cloud server. The second rendering mode may be a local rendering mode, that is, an effects algorithm is performed in the cloud server, and effect rendering processing is performed in the virtual reality device.

According to the live video stream rendering method provided in this embodiment, target data corresponding to the target effect is obtained from a preset configuration platform according to effect identification information, so that a rendering mode corresponding to the target effect can be determined. In addition, a rendering operation on the target effect can be accurately realized according to the rendering mode corresponding to the target effect, thereby improving the accuracy of the rendering operation on the basis of saving the computing power of the virtual reality device.

Further, based on any one of the foregoing embodiments, after Step 203, the method further comprises:
determining, according to the effect identification information, a rendering time corresponding to the target effect in a preset configuration platform;
encoding the rendering time into the target video stream, so that the virtual reality device performs a rendering operation on the live video stream within the rendering time.

In this embodiment, different target effects correspond to different rendering times, and the rendering time may be determined and stored in a configuration platform by for a developer of the target effects. For example, a target effect A need to be rendered at the third second after the user triggers the virtual resource transfer operation, and a target effect B needs to be rendered immediately after the user triggers the virtual resource transfer operation.

Therefore, in order to implement an accurate rendering operation of the target effect, a rendering time corresponding to the target effect may be determined in a preset configuration platform according to the effect identification information. The rendering time is encoded into a target video stream, so that the virtual reality device performs a rendering operation on the live video stream within the rendering time.

According to the live video stream rendering method provided in this embodiment, a rendering time is encoded into a target video stream, so that the virtual reality device can precisely perform a rendering operation on the target effect according to the rendering time, thereby guaranteeing a rendering effect of the target effect.

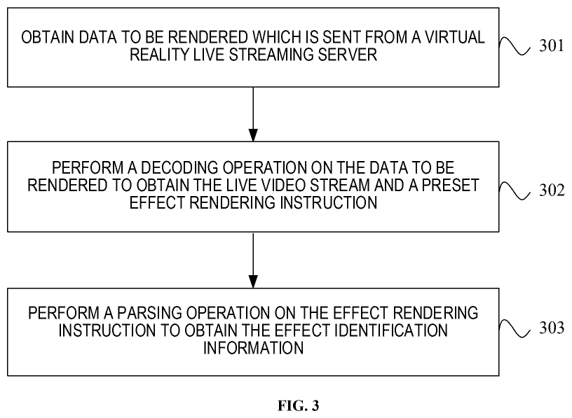

FIG. 3 is a schematic flowchart of a method for rendering a live video stream according to another embodiment of the present disclosure. On the basis of any one of the foregoing embodiments, as shown in FIG. 3, Step 201 comprises:
Step 301: obtaining data to be rendered which is sent from a virtual reality live streaming server;
Step 302: performing a decoding operation on the data to be rendered to obtain the live video stream and a preset effect rendering instruction; and
Step 303: performing a parsing operation on the effect rendering instruction to obtain the effect identification information.

In this embodiment, the virtual reality live streaming server may separately obtain a live video stream and effect identification information, encode the effect identification information together with the live video stream in the form of assembly instructions to obtain data to be rendered, and send the data to be rendered to the cloud server.

By encoding the assembly instruction and the live video stream together, corresponding information for controlling effects rendering can be carried in the process of transmitting the live video stream, so that the effects rendering operation is more adaptable to the personalized demands of the user, thereby improving the user experience.

Accordingly, after obtaining the data to be rendered sent from the virtual reality live streaming server, the cloud server may perform a decoding operation on the data to be rendered to obtain a live video stream and a preset effect rendering instruction. In addition, a parsing operation is performed on the effect rendering instruction to obtain effect identification information.

According to the live video stream rendering method provided in this embodiment, data to be rendered sent from a virtual reality live streaming server is obtained, and a decoding operation is performed on the data to be rendered, so as to obtain a live video stream. In addition, by carrying the effect identification information in the effect rendering instruction, a rendering operation can be accurately performed based on the target effect triggered by the user.

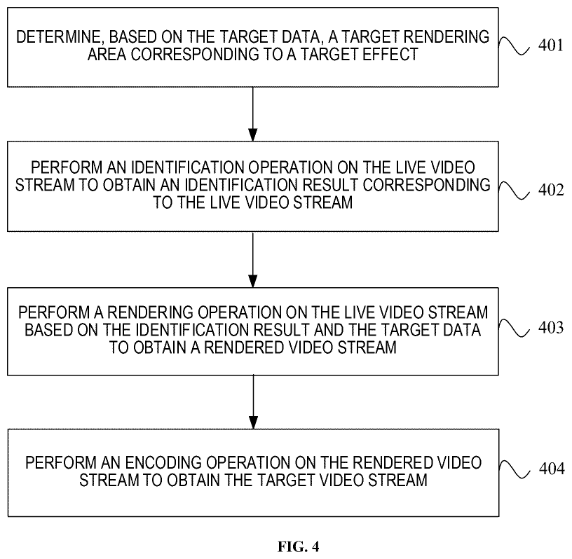

FIG. 4 is a schematic flowchart of a method for rendering a live video stream according to another embodiment of the present disclosure. Based on any one of the foregoing embodiments, the rendering mode comprises a first rendering mode. As shown in FIG. 4, Step 203 comprises:
Step 401: determining, based on the target data, a target rendering area corresponding to a target effect;
Step 402: performing an identification operation on the live video stream to obtain an identification result corresponding to the live video stream, wherein the identification result comprises key point information corresponding to the target rendering area in a live image frame corresponding to the live video stream and depth data corresponding to the live image frame;
Step 403: performing a rendering operation on the live video stream based on the identification result and the target data to obtain a rendered video stream; and
Step 404: performing an encoding operation on the rendered video stream to obtain the target video stream.

In this embodiment, when the rendering mode is the first rendering mode, an effects algorithm and effect rendering processing need to be performed in the cloud server.

After the target data is obtained, information such as a target rendering area and depth corresponding to the target effect may be determined according to the target data. Further, an identification operation can be performed on the live video stream to obtain an identification result corresponding to the live video stream, wherein the identification result comprises key point information corresponding to the target rendering area in a live image frame corresponding to the live video stream and depth data corresponding to the live image frame.

After the identification result corresponding to the live video stream is determined, a rendering operation may be accurately performed on a decoration in the target data according to the key point information and the depth data in the identification result to obtain a rendered video stream. Further, in order to facilitate data transmission, an encoding operation may be performed on the rendered video stream to obtain the target video stream.

Further, based on any one of the foregoing embodiments, Step 403 comprises:
performing, according to the identification result and the target data, a rendering operation on a plurality of live image frames corresponding to the live video stream to obtain a plurality of rendered target image frames;
generating the rendered video stream according to the plurality of rendered target image frames.

In this embodiment, an identification result corresponding to each live image frame can be determined, and a rendering operation is performed on the live image frame according to the identification result and target data. The foregoing operations are repeated for each live image frame to obtain a plurality of rendered target image frames, so that a rendered video stream can be generated according to the plurality of rendered target image frames.

According to the live video stream rendering method provided in this embodiment, when the rendering mode is the first rendering mode, an algorithm identification operation and a rendering operation on the live video stream are implemented in the cloud server, so that a target video stream can be obtained. After the target video stream is sent to the virtual reality device, the virtual reality device does not need to perform effects algorithm and effect rendering processing locally, thereby effectively saving the computing power of the virtual reality device. Furthermore, performing the effects algorithm and effect rendering processing on the cloud server can ensure a rendering effect of the target video stream after the effects rendering and improve the user experience.

FIG. 5 is a schematic flowchart of a method for rendering a live video stream according to another embodiment of the present disclosure. Based on any one of the foregoing embodiments, the rendering mode includes a second rendering mode. As shown in FIG. 5, Step 203 comprises:
Step 501: determining a target rendering area corresponding to a target effect based on the target data;
Step 502: performing an identification operation on the live video stream to obtain an identification result corresponding to the live video stream, wherein the identification result comprises key point information corresponding to the target rendering area in a live image frame corresponding to the live video stream and depth data corresponding to the live image frame; and
Step 503: performing an encoding operation on the live video stream, the identification result and the target data to obtain the target video stream.

In this embodiment, when the rendering mode corresponding to the target effect is the second rendering mode, that is, an effects algorithm operation is performed on the cloud server, and effect rendering processing is performed on the virtual reality device.

After the target data is obtained, information such as a target rendering area and depth corresponding to the target effect may be determined according to the target data. Further, an identification operation can be performed on the live video stream to obtain an identification result corresponding to the live video stream, wherein the identification result comprises key point information corresponding to the target rendering area in a live image frame corresponding to the live video stream and depth data corresponding to the live image frame.

After the identification result corresponding to the live video stream is determined, an encoding operation is performed on the live video stream, the identification result, and the target data to obtain a target video stream. Thus, after obtaining the target video stream, the virtual reality device can perform a rendering operation on the live video stream based on the identification result and the target data subsequently.

Optionally, on the basis of any one of the foregoing embodiments, the performing an identification operation on the live video stream to obtain an identification result corresponding to the live video stream comprises:
identifying, by using a preset key point identification model, key point information corresponding to the target rendering area in a live image frame corresponding to the live video stream;
identifying depth data corresponding to the live image frame through a preset depth identification model; and
determining the key point information and the depth data corresponding to respective live image frames as an identification result corresponding to the live video stream.

In this embodiment, to identify the key point information and the depth data in the live video stream, a key point identification model and a depth identification model may be preset. Therefore, the key point information corresponding to the target rendering area in the live image frame corresponding to the live video stream may be identified using the preset key point identification model. The depth data corresponding to the live image frame may be identified using the preset depth identification model. The key point information and the depth data corresponding to respective live broadcast image frames are determined as an identification result corresponding to the live video stream. By means of the key point identification model and the depth identification model, identification operations on the key point information and the depth data can be accurately realized, thereby improving the rendering effect of effects rendering.

According to the live video stream rendering method provided in this embodiment, when the rendering mode is a second rendering mode, the effects algorithm calculation is performed in the cloud server, and the effect rendering processing is performed in the virtual reality device, thereby ensuring effects real-time performance on the basis of saving computing power of the virtual reality device and enabling the user to perform an interactive operation with the effects.

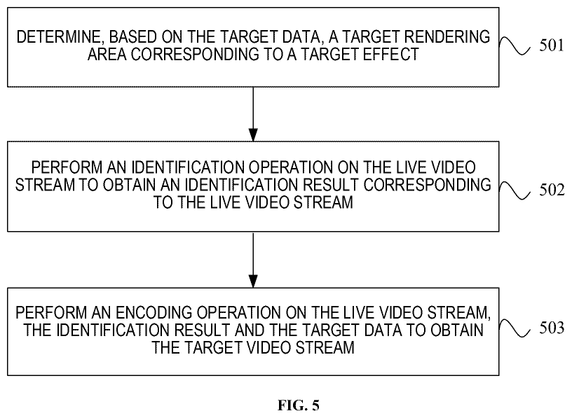

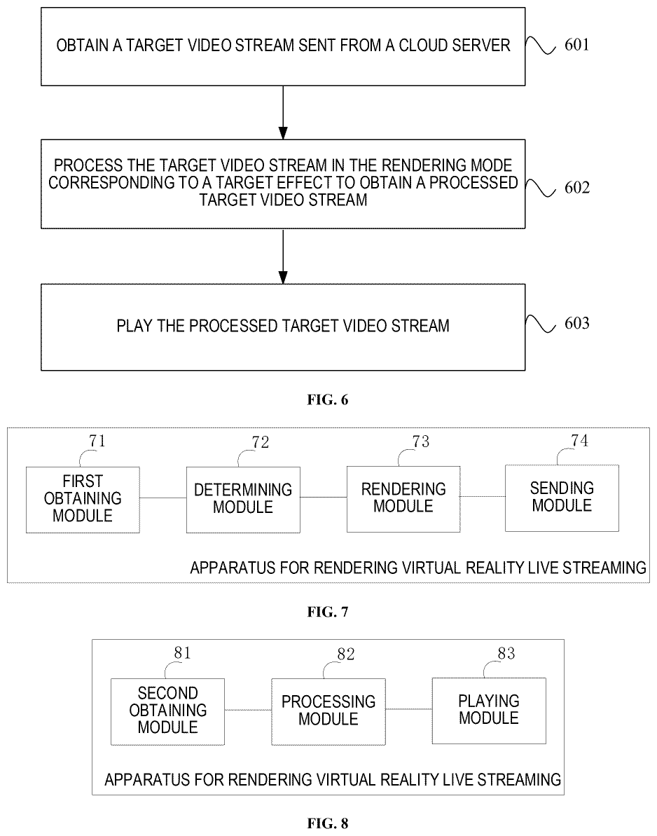

FIG. 6 is a schematic flowchart of a live video stream rendering method according to an embodiment of the present disclosure, which is applied to a virtual reality device. As shown in FIG. 6, the method comprises:
Step 601: obtaining a target video stream sent from the cloud server, the target video stream being obtained after the cloud server performs, according to effect identification information and a live video stream corresponding to virtual reality live streaming, rendering processing by using a rendering mode corresponding to a target effect.
Step 602: processing the target video stream in the rendering mode corresponding to the target effect to obtain a processed target video stream;
Step 603: playing the processed target video stream.

The execution body of this embodiment is a live video stream rendering apparatus, which may be coupled into a virtual reality device. The virtual reality device may be communicatively connected to a cloud server.

In this embodiment, the cloud server may obtain the live video stream and the effect identification information, and determine a rendering mode corresponding to the target effect according to the effect identification information. Rendering processing is performed on the live video stream by using a rendering mode corresponding to the target effect, to obtain a processed target video stream. The target video stream is sent to a preset virtual reality device for playing.

Accordingly, the virtual reality device may obtain the target video stream, and process the target video stream by using a rendering mode corresponding to the target effect, to obtain a processed target video stream. Then, the processed target video stream is played.

In this way, complex effects algorithm operations can be performed on the cloud server, and the virtual reality device can display the rendered target video stream only by performing simple decoding and rendering operations.

According to the live video stream rendering method provided in this embodiment, a target video stream obtained by performing rendering processing in a rendering mode corresponding to the target effect and sent from a cloud server is obtained. Thus, the virtual reality device can display the virtual reality live streaming only by simply processing the target video stream, The computing power of the virtual reality device is effectively saved, and the live streaming effect of the virtual reality live streaming can be guaranteed.

Further, based on any one of the foregoing embodiments, the rendering mode corresponding to the target effect comprises a first rendering mode. Step 602 comprises:
performing a decoding operation on the target video stream to obtain the processed target video stream;
wherein the processed video stream is a video stream rendered by the cloud server.

In this embodiment, when the rendering mode is a first rendering manner, that is, when the effects algorithm and effect rendering processing are performed in the cloud server, the target video stream may be a video stream rendered by the cloud server. Therefore, after obtaining the target video stream, the virtual reality device may perform a decoding operation on the target video stream to obtain a processed target video stream. In this way, the processed target video stream may be directly played without additional data processing on the processed target video stream, thereby effectively reducing the computing power of the virtual reality device.

According to the live video stream rendering method provided in this embodiment, when the rendering mode is a first rendering mode, a decoding operation is performed on a target video stream, so that the processed target video stream can be directly played without performing subsequent effects calculation and effect rendering processing on the processed target video stream. This effectively saves the computing power of the virtual reality device.

Further, based on any one of the foregoing embodiments, the rendering mode corresponding to the target effect comprises a second rendering mode. Step 602 comprises:
performing a decoding operation on the target video stream to obtain a live video stream corresponding to virtual reality live streaming, an identification result corresponding to the live video stream, target data and a rendering time, wherein the identification result comprises key point information corresponding to the target rendering area in a live image frame corresponding to the live video stream and depth data corresponding to the live image frame; and
performing a rendering operation on the live video stream according to the identification result and the target data to obtain a processed target video stream.

In this embodiment, when the rendering mode corresponding to the target effect is a second rendering mode, that is, the effects algorithm operation is performed in the cloud server and effect rendering processing is performed in the virtual reality device, after obtaining a target video stream, a decoding operation may be performed on the target video stream to obtain a live video stream corresponding to the virtual reality live streaming, an identification result corresponding to the live video stream, target data and a rendering time, wherein the identification result comprises key point information corresponding to the target rendering area in a live image frame corresponding to the live video stream and depth data corresponding to the live image frame.

A rendering operation is performed on the live video stream according to the identification result and the target data to obtain a processed target video stream. In this way, subsequently, the virtual reality device may play the target video stream.

Optionally, the virtual reality device may perform effects rendering according to the live video stream, the identification result corresponding to the live video stream, and the target data within the rendering time.

According to the live video stream rendering method provided in this embodiment, when the rendering mode is a second rendering mode, the effects algorithm calculation is performed in the cloud server, and effect rendering processing is performed in the virtual reality device. Thereby, the real-time performance of the effects can be guaranteed on the basis of saving the computing power of the virtual reality device, enabling the user to perform an interactive operation with the effects.

Further, on the basis of any one of the foregoing embodiments, after the performing a decoding operation on the target video stream to obtain a live video stream corresponding to the virtual reality live streaming, an identification result corresponding to the live video stream, and target data, the method further comprises:
determining a rendering time corresponding to the target effect; and
performing a rendering operation on the live video stream according to the identification result and the target data within the rendering time to obtain a processed target video stream.

In this embodiment, different target effects correspond to different rendering times, and the rendering time is obtained by the cloud server from the configuration platform, and is encoded into the target video stream in the form of assembly instructions.

Therefore, in order to implement an accurate rendering operation of a target effect, after a decoding operation is performed on the target video stream, a rendering time corresponding to the target effect may be determined. A rendering operation is performed on the live video stream according to the identification result and the target data within the rendering time to obtain a processed target video stream.

According to the live video stream rendering method provided in this embodiment, the rendering time is encoded into the target video stream, so that the virtual reality device can precisely perform a rendering operation on the target effect according to the rendering time, thereby guaranteeing the rendering effect of the target effect.

Further, based on any one of the foregoing embodiments, the rendering mode corresponding to the target effect comprises a second rendering mode. After Step 601, the method further comprises:
in response to obtaining a user-triggered disabling effects instruction, performing a decoding operation on the target video stream to obtain a live video stream corresponding to virtual reality live streaming, target data and an identification result corresponding to the live video stream, wherein the identification result comprises key point information corresponding to the target rendering area in a live image frame corresponding to the live video stream and depth data corresponding to the live image frame; and
playing the live video stream corresponding to the virtual reality live streaming.

In this embodiment, if the rendering mode corresponding to the target effect is a second rendering mode, that is, an effects algorithm operation is performed in the cloud server, and effect rendering processing is performed in the virtual reality device, a user viewing the virtual reality live streaming may determine, according to an actual requirement, whether to render the target effect.

When the user triggers the disabling effects instruction, after the target video stream is obtained, a decoding operation may be performed on the target video stream to obtain a live video stream corresponding to virtual reality live streaming, target data and an identification result corresponding to the live video stream. The identification result comprises key point information corresponding to the target rendering area in a live image frame corresponding to the live video stream and depth data corresponding to the live image frame.

The virtual reality device does not need to perform a rendering operation on the live video stream according to the identification result and the target data, but may directly display the live video stream.

According to the live video stream rendering method provided in this embodiment, when the rendering mode is a second rendering mode, in response to a user-triggered disabling effects instruction, a rendering operation is not performed on target effect of the second rendering mode, thereby further saving the computing power of the virtual reality device. In addition, the display effect of the virtual reality live streaming can better meet the personalized requirements of the user, thereby improving the user experience.

FIG. 7 is a schematic structural diagram of a live video stream rendering apparatus according to an embodiment of the present disclosure, which is applied to a cloud server. As shown in FIG. 7, the apparatus comprises: a first obtaining module 71, a determining module 72, a rendering module 73, and a sending module 74. The first obtaining module 71 is configured to obtain effect identification information and a live video stream corresponding to virtual reality live streaming, the effect identification information being identification information of a target effect for rendering the live video stream. The determining module 72 is configured to determine a rendering mode corresponding to the target effect according to the effect identification information. The rendering module 73 is configured to perform rendering processing on the live video stream by using the rendering mode corresponding to the target effect to obtain a processed target video stream. The sending module 74 is configured to send the target video stream to a preset virtual reality device for playing.

Further, based on any one of the foregoing embodiments, the first obtaining module is configured to: obtain data to be rendered which is sent from a virtual reality live streaming server; perform a decoding operation on the data to be rendered to obtain the live video stream and a preset effect rendering instruction; and perform a parsing operation on the effect rendering instruction to obtain the effect identification information.

Further, based on any one of the foregoing embodiments, the determining module is configured to: obtain, according to the effect identification information, target data for rendering the target effect in a preset configuration platform; and determine a rendering mode corresponding to the target effect in the target data, wherein the rendering mode comprises a first rendering mode and/or a second rendering mode.

Further, based on any one of the foregoing embodiments, the rendering mode comprises a first rendering mode. The rendering module is configured to: determine, according to the target data, a target rendering area corresponding to the target effect; perform an identification operation on the live video stream to obtain an identification result corresponding to the live video stream, wherein the identification result comprises key point information corresponding to the target rendering area in a live video frame corresponding to the live video stream and depth data corresponding to the live video frame; perform a rendering operation on the live video stream according to the identification result and the target data to obtain a rendered video stream; and perform an encoding operation on the rendered video stream to obtain the target video stream.

Further, based on any one of the above embodiments, the rendering module is configured to: perform a rendering operation on a plurality of live image frames corresponding to the live video stream according to the identification result and the target data, to obtain a plurality of rendered target image frames; and generate the rendered video stream according to the plurality of rendered target image frames.

Further, based on any one of the foregoing embodiments, the rendering mode comprises a second rendering mode. The rendering module is configured to: determine, according to the target data, a target rendering area corresponding to the target effect; perform an identification operation on the live video stream to obtain an identification result corresponding to the live video stream, wherein the identification result comprises key point information corresponding to the target rendering area in a live video frame corresponding to the live video stream and depth data corresponding to the live video frame; and perform an encoding operation on the live video stream, the identification result and the target data to obtain the target video stream.

Further, based on any of the above embodiments, the rendering module is configured to: identify key point information corresponding to the target rendering area in a live image frame corresponding to the live video stream by using a preset key point identification model; identify depth data corresponding to the live image frame by using a preset depth identification model; and determine the key point information and the depth data corresponding to respective live broadcast image frames as an identification result corresponding to the live video stream.

Further, based on any one of the above embodiments, the apparatus further comprises: a determining module configured to determine, according to the effect identification information, a rendering time corresponding to the target effect in a preset configuration platform; and an encoding module configured to encode the rendering time into the target video stream, so as to cause the virtual reality device to perform a rendering operation on the live video stream within the rendering time.

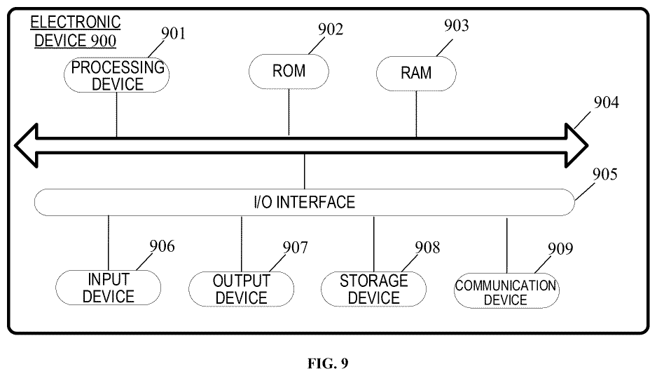

FIG. 8 is a schematic structural diagram of a live video stream rendering apparatus according to an embodiment of the present disclosure, which is applied to a virtual reality device. As shown in FIG. 8, the apparatus comprises: a second obtaining module 81, a processing module 82, and a playing module 83. The second obtaining module 81 is configured to obtain a target video stream sent from a cloud server, the target video stream being obtained after the cloud server performs, according to effect identification information and a live video stream corresponding to virtual reality live streaming, rendering processing in a rendering mode corresponding to the target effect. The processing module 82 is configured to process the target video stream in the rendering mode corresponding to the target effect to obtain a processed target video stream. The playing module 83 is configured to play the processed target video stream.

Further, based on any one of the foregoing embodiments, the rendering mode corresponding to the target effect comprises a first rendering mode. The processing module is configured to perform a decoding operation on the target video stream to obtain the processed target video stream, wherein the processed video stream is a video stream rendered by the cloud server.

Further, based on any one of the foregoing embodiments, the rendering mode corresponding to the target effect comprises a second rendering mode. The processing module is configured to: perform a decoding operation on the target video stream to obtain a live video stream corresponding to the virtual reality live streaming, an identification result corresponding to the live video stream, target data and a rendering time, wherein the identification result comprises key point information corresponding to the target rendering area in a live image frame corresponding to the live video stream and depth data corresponding to the live image frame; and perform a rendering operation on the live video stream according to the identification result and the target data to obtain a processed target video stream.

Further, based on any one of the foregoing embodiments, the processing module is configured to: determine a rendering time corresponding to the target effect; and perform a rendering operation on the live video stream according to the identification result and the target data within the rendering time to obtain a processed target video stream.

Further, based on any one of the foregoing embodiments, the rendering mode corresponding to the target effect comprises a second rendering mode. The apparatus further comprises: a decoding module configured to, in response to obtaining a user-triggered disabling effects instruction, perform a decoding operation on the target video stream to obtain a live video stream corresponding to the virtual reality live streaming, target data and an identification result corresponding to the live video stream, wherein the identification result comprises key point information corresponding to the target rendering area in a live image frame corresponding to the live video stream and depth data corresponding to the live image frame. The playing module is configured to play a live video stream corresponding to the virtual reality live streaming.

The device provided in this embodiment may be used to perform the technical solutions of the foregoing method embodiments, with similar implementation principles and technical effect, which is not repeated in this embodiment.

In order to realize the foregoing embodiments, the embodiments of the present disclosure further provide a cloud rendering system, comprising a cloud server and a virtual reality device, the cloud server being in communication connection with the virtual reality device;
wherein the cloud server is configured to: obtain effect identification information and a live video stream corresponding to virtual reality live streaming, and determine a rendering mode corresponding to target effect according to the effect identification information, the effect identification information being identification information of the target effect for rendering the live video stream;
the cloud server is further configured to: in accordance with a determination that the rendering mode is the first rendering mode, perform effect algorithm processing and effect rendering processing according to the live video stream and the effect identification information to obtain a target video stream;
the cloud server is further configured to: in accordance with a determination that the rendering mode is a second rendering mode, perform effect algorithm processing according to the live video stream and the effect identification information, and send the live video stream and an identification result to the virtual reality device;
the virtual reality device is configured to obtain the live video stream and the identification result sent from the cloud server to perform effect rendering processing.

In order to realize the foregoing embodiments, the embodiments of the present disclosure further provide an electronic device, comprising a processor and a memory.

The memory stores computer-executable instructions.

The processor executes the computer execution instruction stored in the memory, to cause the processor to perform the live video stream rendering method according to any one of the foregoing embodiments.

FIG. 9 is a structural schematic diagram of an electronic device provided by an embodiment of the present disclosure. As shown in FIG. 9, the electronic device 900 may be a terminal device or a server. The terminal device may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal) and the like, and a fixed terminal such as digital TV, a desktop computer and the like. The electronic device shown in FIG. 9 is merely an example and should not be construed as bringing any restriction on the functionality and usage scope of the embodiments of the present disclosure.

As shown in FIG. 9, the electronic device 900 may comprises a processing device (e.g., a central processor, a graphics processor) 901 which is capable of performing various appropriate actions and processes in accordance with programs stored in a read only memory (ROM) 902 or programs loaded from a storage device 908 to a random access memory (RAM) 903. In the RAM 903, there are also stored various programs and data required by the electronic device 900 when operating. The processing device 901, the ROM 902 and the RAM 903 are connected to one another via a bus 904. An input/output (I/O) interface 905 is also connected to the bus 1904.

Usually, the following devices may be connected to the I/O interface 905: an input device 906 including a touch screen, a touch pad, a keyboard, a mouse, a camera, a microphone, an accelerometers, a gyroscope, or the like; an output device 907, such as a liquid-crystal display (LCD), a loudspeaker, a vibrator, or the like; a storage device 908, such as a magnetic tape, a hard disk or the like; and a communication device 909. The communication device 909 allows the electronic device to perform wireless or wired communication with other device so as to exchange data with other device. While FIG. 9 shows the electronic device 900 with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication device 909, or installed from the storage device 908, or installed from the ROM 902. The computer program, when executed by the processing device 901, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

An embodiment of the present disclosure further provides a computer readable storage medium. The computer readable storage medium stores computer executable instructions. The computer executable instructions, when executed by a processor, implement a method for rendering a live video stream according to any one of the above embodiments.

An embodiment of the present disclosure further provides a computer program product, comprising a computer program. The computer program, when executed by a processor, implements a virtual reality live rendering method according to any one of the above embodiments.

The above computer readable medium may be included in the above mentioned electronic device; and it may also exist alone without being assembled into the electronic device.

The computer readable medium carries one or more programs which, when executed by the electronic device, cause the electronic device to perform the method described in the foregoing embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware. Wherein the name of a module does not form any limitation to the module per se. For example, the first obtaining unit may further be described as a “unit for obtaining at least two Internet Protocol addresses.”

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In a first aspect, according to one or more embodiments of the present disclosure, a method for rendering a live video stream is provided, which is applied to a cloud rendering system, the cloud rendering system comprising a cloud server and a virtual reality device, the method comprising:
the cloud server obtaining effect identification information and a live video stream corresponding to virtual reality live streaming, the effect identification information being identification information of a target effect for rendering the live video stream;
the cloud server determining a rendering mode corresponding to the target effect according to the effect identification information, wherein the rendering mode comprises a first rendering mode and/or a second rendering mode;
in accordance with a determination that the rendering mode is a first rendering mode, the cloud server performing effect algorithm processing according to the live video stream and the effect identification information and performing effect rendering processing according to an identification result corresponding to the effect algorithm processing to obtain a target video stream, and sending the target video stream to the virtual reality device, the virtual reality device obtaining and playing the target video stream sent from the cloud server;
in accordance with a determination that the rendering mode is a second rendering mode, the cloud server performing effect algorithm processing according to the live video stream and the effect identification information and sending the live video stream and an identification result to the virtual reality device, the virtual reality device performing effect rendering processing according to the live video stream and an algorithm result to obtain a processed target video stream, and playing the processed target video stream.

According to one or more embodiments of the present disclosure, the cloud server performing effect algorithm processing according to the live video stream and the effect identification information comprises:
the cloud server obtaining target data for rendering the target effect in a preset configuration platform according to the effect identification information;
the cloud server determining a target rendering area corresponding to the target effect according to the target data; and
the cloud server performing an identification operation on the live video stream to obtain an identification result corresponding to the live video stream, wherein the identification result comprises key point information corresponding to the target rendering area in a live image frame corresponding to the live video stream and depth data corresponding to the live image frame.

According to one or more embodiments of the present disclosure, the performing effect rendering processing according to an identification result of the effect algorithm processing to obtain a target video stream comprises:
the cloud server performing a rendering operation on the live video stream according to the identification result and the target data to obtain a rendered video stream; and
the cloud server performing an encoding operation on the rendered video stream to obtain the target video stream.

According to one or more embodiments of the present disclosure, after the cloud server determining a rendering mode corresponding to the target effect according to the effect identification information, the method further comprises:
the cloud server obtaining target data for rendering the target effect in a preset configuration platform according to the effect identification information;
the cloud server determining a target rendering area corresponding to the target effect according to the target data;
the cloud server performing an identification operation on the live video stream to obtain an identification result corresponding to the live video stream, wherein the identification result comprises key point information corresponding to the target rendering area in a live image frame corresponding to a live video stream and depth data corresponding to the live image frame; and
the cloud server performing an encoding operation on the live video stream, the identification result and the target data to obtain the target video stream, and sending the target video stream to the virtual reality device.

According to one or more embodiments of the present disclosure, after the sending the target video stream to the virtual reality device, the method further comprises:
the virtual reality device obtaining the target video stream, and performing a decoding operation on the target video stream to obtain a live video stream corresponding to virtual reality live streaming, target data and an identification result corresponding to the live video stream, wherein the identification result comprises key point information corresponding to the target rendering area in a live image frame corresponding to the live video stream and depth data corresponding to the live image frame; and
performing a rendering operation on the live video stream according to the identification result and the target data to obtain a processed target video stream.

In a second aspect, according to one or more embodiments of the present disclosure, a method for rendering a live video stream is provided, which is applied to a cloud server, the method comprising:
obtaining effect identification information and a live video stream corresponding to virtual reality live streaming, the effect identification information being identification information of a target effect for rendering the live video stream;
determining a rendering mode corresponding to the target effect according to the effect identification information;
performing rendering processing on the live video stream in the rendering mode corresponding to the target effect to obtain a processed target video stream; and
sending the target video stream to a preset virtual reality device for playing.

According to one or more embodiments of the present disclosure, the obtaining effect identification information and a live video stream corresponding to virtual reality live streaming comprises:
obtaining data to be rendered which is sent from a virtual reality live streaming server;
performing a decoding operation on the data to be rendered to obtain the live video stream and a preset effect rendering instruction; and
performing a parsing operation on the effect rendering instruction to obtain the effect identification information.

According to one or more embodiments of the present disclosure, the determining a rendering mode corresponding to the target effect according to the effect identification information comprises:
obtaining, according to the effect identification information, target data for rendering the target effect in a preset configuration platform; and
determining a rendering mode corresponding to the target effect in the target data,
wherein the rendering mode comprises a first rendering mode and/or a second rendering mode.

According to one or more embodiments of the present disclosure, the rendering mode comprises a first rendering mode;
the performing rendering operation on the live video stream in a rendering mode corresponding to the target effect to obtain a processed target video stream comprises:
determining, according to the target data, a target rendering area corresponding to the target effect;
performing an identification operation on the live video stream to obtain an identification result corresponding to the live video stream, wherein the identification result comprises key point information corresponding to the target rendering area in a live video frame corresponding to the live video stream and depth data corresponding to the live video frame;
performing a rendering operation on the live video stream according to the identification result and the target data to obtain a rendered video stream; and
performing an encoding operation on the rendered video stream to obtain the target video stream.

According to one or more embodiments of the present disclosure, the performing a rendering operation on the live video stream according to the identification result and the target data to obtain the target video stream comprises:
performing a rendering operation on a plurality of live image frames corresponding to the live video stream according to the identification result and the target data, to obtain a plurality of rendered target image frames; and
generating the rendered video stream according to the plurality of rendered target image frames.

According to one or more embodiments of the present disclosure, the rendering mode comprises a second rendering mode;
the performing rendering operation on the live video stream in a rendering mode corresponding to the target effect to obtain a processed target video stream comprises:
determining, according to the target data, a target rendering area corresponding to the target effect;
performing an identification operation on the live video stream to obtain an identification result corresponding to the live video stream, wherein the identification result comprises key point information corresponding to the target rendering area in a live video frame corresponding to the live video stream and depth data corresponding to the live video frame; and
performing an encoding operation on the live video stream, the identification result and the target data to obtain the target video stream.

According to one or more embodiments of the present disclosure, the performing an identification operation on the live video stream to obtain an identification result corresponding to the live video stream comprises:
identifying key point information corresponding to the target rendering area in a live image frame corresponding to the live video stream by using a preset key point identification model;
identifying depth data corresponding to the live image frame by using a preset depth identification model; and
determining the key point information and the depth data corresponding to respective live broadcast image frames as an identification result corresponding to the live video stream.

According to one or more embodiments of the present disclosure, the performing rendering processing on the live video stream in a rendering mode corresponding to the target effect to obtain a processed target video stream, the method further comprises:
determining, according to the effect identification information, a rendering time corresponding to the target effect in a preset configuration platform; and
encoding the rendering time into the target video stream, so as to cause the virtual reality device to perform a rendering operation on the live video stream within the rendering time.

In a third aspect, according to one or more embodiments of the present disclosure, a method for rendering a live video stream is provided, which is applied to a virtual reality device, the method comprising:
obtaining a target video stream sent from a cloud server, the target video stream being obtained after the cloud server performs rendering processing in a rendering mode corresponding to the target effect according to effect identification information and a live video stream corresponding to virtual reality live streaming;
processing the target video stream in the rendering mode corresponding to the target effect to obtain a processed target video stream; and
playing the processed target video stream.

According to one or more embodiments of the present disclosure, the rendering mode corresponding to the target effect comprises a first rendering mode;
the processing the target video stream in the rendering mode corresponding to the target effect to obtain a processed target video stream comprises:
performing a decoding operation on the target video stream to obtain the processed target video stream;
wherein the processed video stream is a video stream rendered by the cloud server.

According to one or more embodiments of the present disclosure, the rendering mode corresponding to the target effect comprises a second rendering mode; the processing the target video stream in the rendering mode corresponding to the target effect comprises:
performing a decoding operation on the target video stream to obtain a live video stream corresponding to the virtual reality live streaming, an identification result corresponding to the live video stream, target data and a rendering time, wherein the identification result comprises key point information corresponding to the target rendering area in a live image frame corresponding to the live video stream and depth data corresponding to the live image frame; and
performing a rendering operation on the live video stream according to the identification result and the target data to obtain a processed target video stream.

According to one or more embodiments of the present disclosure, after the performing a decoding operation on the target video stream to obtain a live video stream corresponding to virtual reality live streaming, target data and an identification result corresponding to the live video stream, the method further comprises:
determining a rendering time corresponding to the target effect; and
performing a rendering operation on the live video stream according to the identification result and the target data within the rendering time to obtain a processed target video stream.

According to one or more embodiments of the present disclosure, the rendering mode corresponding to the target effect comprises a second rendering mode;
after the obtaining a target video stream sent from the cloud server, the method further comprises:
in response to obtaining a user-triggered disabling effects instruction, performing a decoding operation on the target video stream to obtain a live video stream corresponding to the virtual reality live streaming, target data and an identification result corresponding to the live video stream, wherein the identification result comprises key point information corresponding to the target rendering area in a live image frame corresponding to the live video stream and depth data corresponding to the live image frame; and
playing a live video stream corresponding to the virtual reality live streaming.

In a fourth aspect, according to one or more embodiments of the present disclosure, an apparatus for rendering a live video stream is provided, which is applied to a cloud rendering system, the apparatus comprising:
a first obtaining module configured to obtain effect identification information and a live video stream corresponding to virtual reality live streaming, the effect identification information being identification information of a target effect for rendering the live video stream;
a determining module configured to determine a rendering mode corresponding to the target effect according to the effect identification information;
a rendering module configured to perform rendering processing on the live video stream by using the rendering mode corresponding to the target effect to obtain a processed target video stream; and
a sending module configured to send the target video stream to a preset virtual reality device for playing.

According to one or more embodiments of the present disclosure, the first obtaining module is configured to:
obtain data to be rendered which is sent from a virtual reality live streaming server;
perform a decoding operation on the data to be rendered to obtain the live video stream and a preset effect rendering instruction; and
perform a parsing operation on the effect rendering instruction to obtain the effect identification information.

According to one or more embodiments of the present disclosure, the determining module is configured to:
obtain, according to the effect identification information, target data for rendering the target effect in a preset configuration platform; and
determine a rendering mode corresponding to the target effect in the target data,
wherein the rendering mode comprises a first rendering mode and/or a second rendering mode.

According to one or more embodiments of the present disclosure, the rendering mode comprises a first rendering mode.

The rendering module is configured to:
determine, according to the target data, a target rendering area corresponding to the target effect;
perform an identification operation on the live video stream to obtain an identification result corresponding to the live video stream, wherein the identification result comprises key point information corresponding to the target rendering area in a live video frame corresponding to the live video stream and depth data corresponding to the live video frame;
perform a rendering operation on the live video stream according to the identification result and the target data to obtain a rendered video stream; and
perform an encoding operation on the rendered video stream to obtain the target video stream.

According to one or more embodiments of the present disclosure, the rendering module is configured to:
perform a rendering operation on a plurality of live image frames corresponding to the live video stream according to the identification result and the target data, to obtain a plurality of rendered target image frames; and
generate the rendered video stream according to the plurality of rendered target image frames.

According to one or more embodiments of the present disclosure, the rendering mode comprises a second rendering mode.

The rendering module is configured to:
determine, according to the target data, a target rendering area corresponding to the target effect;
perform an identification operation on the live video stream to obtain an identification result corresponding to the live video stream, wherein the identification result comprises key point information corresponding to the target rendering area in a live video frame corresponding to the live video stream and depth data corresponding to the live video frame; and
perform an encoding operation on the live video stream, the identification result and the target data to obtain the target video stream.

According to one or more embodiments of the present disclosure, the rendering module is configured to:
identify key point information corresponding to the target rendering area in a live image frame corresponding to the live video stream by using a preset key point identification model;
identify depth data corresponding to the live image frame by using a preset depth identification model; and
determine the key point information and the depth data corresponding to respective live broadcast image frames as an identification result corresponding to the live video stream.

According to one or more embodiments of the present disclosure, the apparatus further comprises:
a determining module configured to determine, according to the effect identification information, a rendering time corresponding to the target effect in a preset configuration platform; and
an encoding module configured to encode the rendering time into the target video stream, so as to cause the virtual reality device to perform a rendering operation on the live video stream within the rendering time.

In a fifth aspect, according to one or more embodiments of the present disclosure, an apparatus for rendering a live video stream is provided, which is applied to a virtual reality device, the apparatus comprising:
a second obtaining module configured to obtain a target video stream sent from a cloud server, the target video stream being obtained after the cloud server performs, according to effect identification information and a live video stream corresponding to virtual reality live streaming, rendering processing in a rendering mode corresponding to the target effect;
a processing module configured to process the target video stream in the rendering mode corresponding to the target effect to obtain a processed target video stream; and
a playing module configured to play the processed target video stream.

According to one or more embodiments of the present disclosure,, the rendering mode corresponding to the target effect comprises a first rendering mode;
the processing module is configured to
perform a decoding operation on the target video stream to obtain the processed target video stream,
wherein the processed video stream is a video stream rendered by the cloud server.

According to one or more embodiments of the present disclosure, the rendering mode corresponding to the target effect comprises a second rendering mode;
the processing module is configured to:
perform a decoding operation on the target video stream to obtain a live video stream corresponding to the virtual reality live streaming, an identification result corresponding to the live video stream, target data and a rendering time, wherein the identification result comprises key point information corresponding to the target rendering area in a live image frame corresponding to the live video stream and depth data corresponding to the live image frame; and
perform a rendering operation on the live video stream according to the identification result and the target data to obtain a processed target video stream.

According to one or more embodiments of the present disclosure, the processing module is configured to:
determine a rendering time corresponding to the target effect; and
perform a rendering operation on the live video stream according to the identification result and the target data within the rendering time to obtain a processed target video stream.

According to one or more embodiments of the present disclosure, the rendering mode corresponding to the target effect comprises a second rendering mode;
the apparatus further comprises:
a decoding module configured to, in response to obtaining a user-triggered disabling effects instruction, perform a decoding operation on the target video stream to obtain a live video stream corresponding to the virtual reality live streaming, target data and an identification result corresponding to the live video stream, wherein the identification result comprises key point information corresponding to the target rendering area in a live image frame corresponding to the live video stream and depth data corresponding to the live image frame; and
a playing module configured to play a live video stream corresponding to the virtual reality live streaming.

In a sixth aspect, according to one or more embodiments of the present disclosure, a cloud rendering system is provided, comprising a cloud server and a virtual reality device, the cloud server being in communication connection with the virtual reality device;
wherein the cloud server is configured to: obtain effect identification information and a live video stream corresponding to virtual reality live streaming, and determine a rendering mode corresponding to target effect according to the effect identification information, the effect identification information being identification information of the target effect for rendering the live video stream;
the cloud server is further configured to: in accordance with a determination that the rendering mode is the first rendering mode, perform effect algorithm processing and effect rendering processing according to the live video stream and the effect identification information to obtain a target video stream;
the cloud server is further configured to: in accordance with a determination that the rendering mode is a second rendering mode, perform effect algorithm processing according to the live video stream and the effect identification information, and send the live video stream and an identification result to the virtual reality device;
the virtual reality device is configured to obtain the live video stream and the identification result sent from the cloud server to perform effect rendering processing.

In a seventh aspect, according to one or more embodiments of the present disclosure, an electronic device is provided, comprising: at least one processor and a memory; wherein
the memory stores computer-executable instructions;
the at least one processor executes the computer-executable instructions stored in the memory so as to implement the method for rendering a live video stream according to the first aspect and various possible designs of the first aspect or the second aspect and various possible designs of the second aspect.

In an eighth aspect, according to one or more embodiments of the present disclosure, a computer-readable storage medium is provided, wherein the computer-readable storage medium stores computer-executable instructions which, when executed by a processor, implement the method for rendering a live video stream according to the first aspect and various possible designs of the first aspect or the second aspect and various possible designs of the second aspect.

In a ninth aspect, according to one or more embodiments of the present disclosure, a computer program product is provided, comprising a computer program, wherein the computer program, when executed by a processor, implements the method for rendering a live video stream according to the first aspect and various possible designs of the first aspect or the second aspect and various possible designs of the second aspect.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. A method for rendering a live video stream in a cloud rendering system, comprising:
obtaining, at a cloud server of the cloud rendering system, effect identification information and a live video stream corresponding to virtual reality live streaming, the effect identification information being identification information of a target effect for rendering the live video stream, wherein the cloud rendering system comprises the cloud server and a virtual reality device;
determining, at the cloud server, a rendering mode corresponding to the target effect based on the effect identification information, wherein the rendering mode comprises a first rendering mode and/or a second rendering mode;
in accordance with a determination that the rendering mode is a first rendering mode,
performing, at the cloud server, effect algorithm processing based on the live video stream and the effect identification information, performing effect rendering processing based on an identification result corresponding to the effect algorithm processing to obtain a target video stream, and sending the target video stream to the virtual reality device, and
obtaining and playing, at the virtual reality device, the target video stream sent from the cloud server; and
in accordance with a determination that the rendering mode is a second rendering mode,
performing at the cloud server, effect algorithm processing based on the live video stream and the effect identification information and sending the live video stream and an identification result to the virtual reality device, and
performing, at the virtual reality device, effect rendering processing based on the live video stream and an algorithm result to obtain a processed target video stream, and playing the processed target video stream.

2. The method of claim 1, wherein the cloud server performing effect algorithm processing based on the live video stream and the effect identification information comprises:
obtaining, at the cloud server, target data for rendering the target effect in a preset configuration platform based on the effect identification information;
determining, at the cloud server, a target rendering area corresponding to the target effect based on the target data; and
performing, at the cloud server, an identification operation on the live video stream to obtain an identification result corresponding to the live video stream, wherein the identification result comprises key point information corresponding to the target rendering area in a live image frame corresponding to the live video stream and depth data corresponding to the live image frame.

3. The method of claim 1, wherein the performing effect rendering processing based on an identification result of the effect algorithm processing to obtain a target video stream comprises:
performing, at the cloud server, a rendering operation on the live video stream based on the identification result and the target data to obtain a rendered video stream; and
performing, at the cloud server, an encoding operation on the rendered video stream to obtain the target video stream.

4. The method of claim 1, further comprising:
after the cloud server determining a rendering mode corresponding to the target effect based on the effect identification information,
obtaining, at the cloud server, target data for rendering the target effect in a preset configuration platform based on the effect identification information;
determining, at the cloud server, a target rendering area corresponding to the target effect based on the target data;
performing, at the cloud server, an identification operation on the live video stream to obtain an identification result corresponding to the live video stream, wherein the identification result comprises key point information corresponding to the target rendering area in a live image frame corresponding to a live video stream and depth data corresponding to the live image frame; and
performing, at the cloud server, an encoding operation on the live video stream, the identification result and the target data to obtain the target video stream, and sending the target video stream to the virtual reality device.

5. The method of claim 4, further comprising:
after the sending the target video stream to the virtual reality device,
obtaining, at the virtual reality device, the target video stream, and performing a decoding operation on the target video stream to obtain a live video stream corresponding to virtual reality live streaming, target data and an identification result corresponding to the live video stream, wherein the identification result comprises key point information corresponding to the target rendering area in a live image frame corresponding to the live video stream and depth data corresponding to the live image frame; and
performing a rendering operation on the live video stream based on the identification result and the target data to obtain a processed target video stream.

6. A method for rendering a live video stream at a cloud server, comprising:
obtaining effect identification information and a live video stream corresponding to virtual reality live streaming, the effect identification information being identification information of a target effect for rendering the live video stream;
determining a rendering mode corresponding to the target effect based on the effect identification information;
performing rendering processing on the live video stream in the rendering mode corresponding to the target effect to obtain a processed target video stream; and
sending the target video stream to a preset virtual reality device for playing.

7. The method of claim 6, wherein the obtaining effect identification information and a live video stream corresponding to virtual reality live streaming comprises:
obtaining data to be rendered which is sent from a virtual reality live streaming server;
performing a decoding operation on the data to be rendered to obtain the live video stream and a preset effect rendering instruction; and
performing a parsing operation on the effect rendering instruction to obtain the effect identification information.

8. The method of claim 6, wherein the determining a rendering mode corresponding to the target effect based on the effect identification information comprises:
obtaining, based on the effect identification information, target data for rendering the target effect in a preset configuration platform; and
determining a rendering mode corresponding to the target effect in the target data,
wherein the rendering mode comprises a first rendering mode and/or a second rendering mode.

9. The method of claim 8, wherein the rendering mode comprises a first rendering mode, and
the performing rendering processing on the live video stream in a rendering mode corresponding to the target effect to obtain a processed target video stream comprises:
determining, based on the target data, a target rendering area corresponding to the target effect;
performing an identification operation on the live video stream to obtain an identification result corresponding to the live video stream, wherein the identification result comprises key point information corresponding to the target rendering area in a live video frame corresponding to the live video stream and depth data corresponding to the live video frame;
performing a rendering operation on the live video stream based on the identification result and the target data to obtain a rendered video stream; and
performing an encoding operation on the rendered video stream to obtain the target video stream.

10. The method of claim 8, wherein the rendering mode comprises a second rendering mode, and
the performing rendering processing on the live video stream in a rendering mode corresponding to the target effect to obtain a processed target video stream comprises:
determining, based on the target data, a target rendering area corresponding to the target effect;
performing an identification operation on the live video stream to obtain an identification result corresponding to the live video stream, wherein the identification result comprises key point information corresponding to the target rendering area in a live video frame corresponding to the live video stream and depth data corresponding to the live video frame; and
performing an encoding operation on the live video stream, the identification result and the target data to obtain the target video stream.

11. A method for rendering a live video stream at a virtual reality device, comprising:
obtaining a target video stream sent from a cloud server, the target video stream being obtained after performing, by the cloud server, rendering processing in a rendering mode corresponding to the target effect based on effect identification information and a live video stream corresponding to virtual reality live streaming;
processing the target video stream in the rendering mode corresponding to the target effect to obtain a processed target video stream; and
playing the processed target video stream.

12. The method of claim 11, wherein the rendering mode corresponding to the target effect comprises a first rendering mode, and
the processing the target video stream in the rendering mode corresponding to the target effect to obtain a processed target video stream comprises:
performing a decoding operation on the target video stream to obtain the processed target video stream,
wherein the processed video stream is a video stream rendered by the cloud server.

13. The method of claim 11, wherein the rendering mode corresponding to the target effect comprises a second rendering mode, and
the processing the target video stream in the rendering mode corresponding to the target effect comprises:
performing a decoding operation on the target video stream to obtain a live video stream corresponding to the virtual reality live streaming, an identification result corresponding to the live video stream, target data and a rendering time, wherein the identification result comprises key point information corresponding to the target rendering area in a live image frame corresponding to the live video stream and depth data corresponding to the live image frame; and
performing a rendering operation on the live video stream based on the identification result and the target data to obtain a processed target video stream.

14. The method of claim 11, wherein the rendering mode corresponding to the target effect comprises a second rendering mode, and
the method further comprises:
after the obtaining a target video stream sent from the cloud server,
in response to obtaining a user-triggered disabling effects instruction, performing a decoding operation on the target video stream to obtain a live video stream corresponding to the virtual reality live streaming, target data and an identification result corresponding to the live video stream, wherein the identification result comprises key point information corresponding to the target rendering area in a live image frame corresponding to the live video stream and depth data corresponding to the live image frame; and
playing a live video stream corresponding to the virtual reality live streaming.

15-20. (canceled)
